(19) United States
(12) Patent Application Publication
(10) Pub. No.: US 2009/0000649 A1
(43) Pub. Date: Jan. 1, 2009

(54) METHOD FOR CLEANING WAFER

(76) Inventor: Sang-Seop Lee, Gangdong-gu (KR)

Correspondence Address: SHERR & VAUGHN, PLLC, 620 HERNDON PARKWAY, SUITE 200, HERNDON, VA, 20170, US

(21) Appl. No.: 12/145,538

(22) Filed: Jun. 25, 2008

(30) Foreign Application Priority Data
Jun. 26, 2007 (KR) 1020070062809

(51) Int. Cl. B08B 3/08; B08B 3/04

(52) U.S. Cl. 134/28; 134/26

(57) ABSTRACT

A method for cleaning a wafer by removing residues from the surface of a wafer where metals are reacted to form compounds. The cleaning method may include first residue from predetermined areas of the wafer (e.g., uppermost surface of the gate electrode and/or source/drain regions where suicides are formed) using at least one selected from a sulfuric acid cleaning solution, a first mixed cleaning solution and a second mixed cleaning solution, then removing oxide films from the predetermined areas using a diluted hydrofluoric acid cleaning solution, and then removing a second residue derived from the removal of the oxide films using the first mixed cleaning solution. Accordingly, the method efficiently removes the first and second residues left on the surfaces of the predetermined areas.

The present application claims priority under 35 U.S.C. §119 to Korean Patent Application No. 10-2007-0062809 (filed on Jun. 26, 2007), which is hereby incorporated by reference in its entirety.

### BACKGROUND

The rapid increase in obtaining high integration of semiconductors has reached a state such that sources/drains and gates, acting as junctions, which come in contact with contact metals, are made of silicon, and thus, have a high sheet resistance (SR). In particular, gate polysilicon has a considerably high sheet resistance of between 5 to 40 Ω/sq. Accordingly, in order to increase the driving speed of chips, sheet resistances of regions, where junctions are in contact with metal lines, must be reduced. Due to having a high specific resistance, polysilicon increases sheet resistance, which may impede a time constant (RC), thus acting as a limiting factor on increasing the level of integration. Research has been conducted on the use of metal silicides as a line material capable of reducing a specific resistance of polysilicon while maintaining characteristics and thermal stability thereof. Metal silicides enable a reduction in sheet resistance of regions where metals are in contact with junctions.

A method of forming a semiconductor substrate may include forming polysilicon gates and then gate sidewall spacers on and/or over sidewalls of the gates to separate the gates from junctions. A metal layer composed of titanium (Ti) or cobalt (Co) can then be deposited on and/or over the resultant structure by a sputtering method. A rapid thermal process (RTP) can then be conducted to form a silicide layer composed of TiSi₂ or CoSi₂. Such a silicide is a compound having a low sheet resistance formed by the reaction of metals that occur in a region only where Ti or Co is in contact with polysilicon. When the resultant structure is treated with a wet etching solution, Ti or Co residues left on and/or over insulating films such as sidewall spacers, which do not participate in the formation reaction of the silicide, are selectively removed. Subsequently, the silicide may be subjected to annealing.

The afore-mentioned silicide formation pattern, which requires no additional patterning process, is referred to as a self-aligned silicide, or salicide. The salicide has a low specific resistance, which is an advantageous characteristic of cobalt-employing silicide. On the other hand, impurities which are ion-implanted on and/or over the substrate in order to enhance contact resistance and conductivity, are diffused to form a secondary phase CoSi₂. Accordingly, problems such as increases in both surface roughness and contact resistance may result.

### SUMMARY

Embodiments relate to a method for cleaning a wafer having residues on a surface thereof where metals are reacted to form compounds.

Embodiments relate to a method for cleaning a wafer in which residues are efficiently removed to enable subsequent processes to be favorably conducted and thus, increase yield.

Embodiments relate to a method for cleaning a wafer that may include at least one of the following steps: removing a first residue left on and/or over the surface of a wafer where metals are reacted to form compounds, using at least one selected from a sulfuric acid cleaning solution, a first mixed cleaning solution and a second mixed cleaning solution; and then removing oxide films left on and/or over the wafer surface using a dilute hydrofluoric acid cleaning solution; and then removing a second residue including particles present on and/or over the wafer surface, derived from the removal of the oxide films, using the first mixed cleaning solution. In accordance with embodiments, the first mixed cleaning solution may be composed of ammonia, hydrogen peroxide and water and the second mixed cleaning solution may be composed of hydrochloric acid (HCl), hydrogen peroxide (H₂O₂) and water (H₂O).

Embodiments relate to a method that may include at least one of the following steps: performing a first cleaning process on a surface of a gate electrode and a source/drain electrode, respectively, using a first cleaning solution; and then performing a second cleaning process on the surface of the gate electrode and the source/drain electrode, respectively, using a second cleaning solution; and then performing a third cleaning process on the surface of the gate electrode and the source/drain electrode, respectively, using the second cleaning solution; and then performing a fourth cleaning process on the surface of the gate electrode and the source/drain electrode, respectively, using a third cleaning solution; and then performing a fifth cleaning process on the surface of the gate electrode and the source/drain electrode, respectively, using the second cleaning solution.

### DRAWINGS

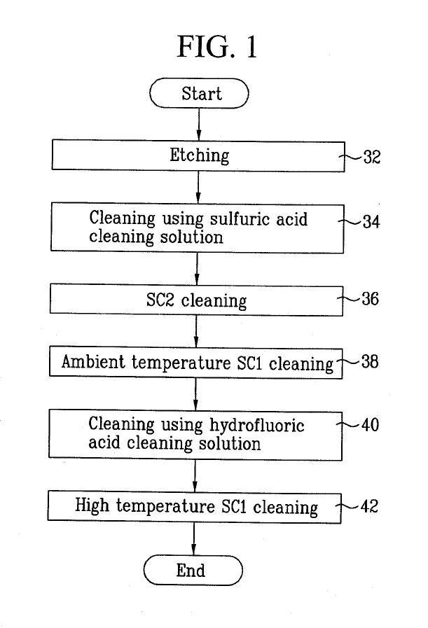

Example FIG. 1 illustrates a method for cleaning a wafer in accordance with embodiments.

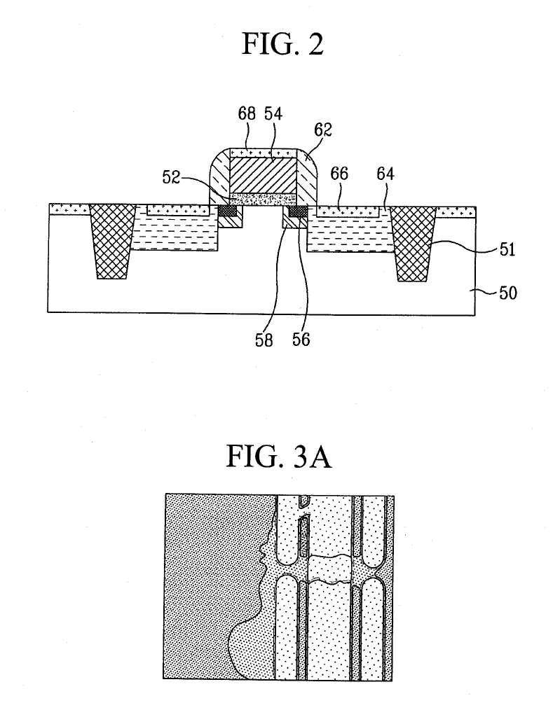

Example FIG. 2 illustrates a semiconductor device to which the cleaning process in accordance with embodiments is applicable.

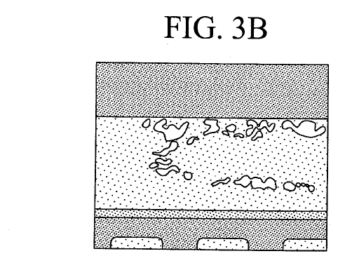

Example FIGS. 3A and 3B illustrate defects of a silicide after a wafer cleaning process is performed.

### DESCRIPTION

As illustrated in example FIG. 2, a semiconductor device to which the cleaning process in accordance with embodiments is applicable may include device separation film 51 defining an active region in substrate 50. Gate insulating film 52 may be formed on and/or over substrate 50 and gate electrode 54 may then be formed on and/or over gate insulating film 52. Lightly doped drain (LDD) region 56 may be formed in the active region at both sides under gate electrode 54 and halo ion-implanted region 58 may be formed by halo-ion implantation. Gate spacers 62 may be formed on and/or over sidewalls of gate electrode 54. Source/drain regions 64 may be formed by high-concentration ion implantation in substrate 50. First silicide layer 68 may be formed on and/or over gate electrode 54 and second silicide layers 66 may be formed on and/or over source/drain regions 64.

As illustrated in example FIGS. 1 and 2, a wafer may be formed on and/or over substrate 50, gate spacer 62 may be formed on and/or over sidewalls of gate electrode 54. In step 32, the resultant structure may then be subjected to ashing. After the performing step 32, first residues remaining on and/or over the wafer surface, where metals will be reacted to form compounds, are removed using at least one selected from a sulfuric acid cleaning solution, a first mixed cleaning solution and a second mixed cleaning solution (Steps 34 to 38). The expression “on and/or over the wafer surface, where metals will be reacted to form compounds” as used herein means surfaces of the contacts illustrated in example FIG. 2, such as gate electrode 54 and source/drain regions 64. The metal used to form compounds may be at least one of cobalt (Co), titanium (Ti), and the like, and the compound may be a salicide prepared by a salicide method using cobalt or titanium.

In essence, step 34 requires removal of the first residue using the sulfuric acid cleaning solution. The first residue removed by the sulfuric acid cleaning solution may be residues left on and/or over photosensitive films after ion-implantation. For example, as illustrated in example FIG. 2, the residues left on and/or over surfaces of gate electrode 54 and source/drain regions 64 may be removed using the sulfuric acid cleaning solution by high-concentration ion-implantion to form source/drain region 64, low-concentration ion-implantion to form LDD regions 56, and/or halo ion-implantion to form halo ion-implanted regions 58. The sulfuric acid cleaning solution may be a cleaning solution composed of a mixture of sulfuric acid (H₂SO₄) and hydrogen peroxide (H₂O₂). For example, the wafer may be dipped in the sulfuric acid cleaning solution with a mixing ratio of sulfuric acid to hydrogen peroxide of 4.8˜7.2 (97%): 0.8˜1.2 (30%) at a cleaning atmosphere temperature range of between 85 to 115° C. The sulfuric acid cleaning solution exhibits superior residue (e.g., photosensitive film) removal efficiency, but cannot eliminate the presence of metal composites on and/or over the surface due to metals used to implant impurity ions such as arsenic (As).

Accordingly, removal of first residues such as impurity metal ions remaining on and/or over the surface after performing step 34 may be removed in step 36 using a second mixed cleaning solution (SC2). The term “SC” as used herein means “standard clean”. The second mixed cleaning solution (SC2) may include a mixture of hydrochloric acid (HCl), hydrogen peroxide and water (H₂O) at a a mixing ratio of 0.8˜1:1.6˜2.4:8˜12. The second cleaning may be performed at a cleaning atmosphere temperature range of between 20 to 30° C.

After the process of step 36 is completed, other first residues such as fine organics, inorganics and particles left on and/or over the surface can be removed in step 38 at an ambient temperature using the first mixed cleaning solution (SC1) of a mixture of ammonia, hydrogen peroxide and water. For example, the wafer may be dipped in the first mixed cleaning solution at a mixing ratio of 0.8˜1.2:0.8˜1.2:16˜24 and at a cleaning atmosphere temperature range of between 20 to 30° C.

After the process of step 38 is completed, oxide films left on and/or over the surfaces of gate electrode 54 and source/drain region 64, i.e., the regions where silicides 66 and 68 will be formed, may be removed in step 40 using a dilute hydrofluoric acid cleaning solution. For example, a buffer oxide film may be formed on and/or over the entire surface of substrate 50 including gate electrode 54 and the buffer oxide film may then be subjected to entire-surface etching to form gate spacer 62. Oxide remnants created by the entire-surface etching may be removed in step 40. The dilute hydrofluoric acid cleaning solution used herein is a cleaning solution composed of water and hydrofluoric acid (HF). For example, the wafer may be dipped for 200 seconds in a cleaning solution in which the mixing ratio of water to hydrofluoric acid (HF) is 80˜120:0.8˜1.2 and the cleaning atmosphere temperature is in a range of between 20 to 30° C. In accordance with embodiments, the removal of oxide films using the hydrofluoric acid cleaning solution in step 40 may be repeated a plurality of times. For example, the wafer may be dipped twice under the afore-mentioned cleaning atmosphere for 100 seconds each.

After the process of step 40 is completed, second residues such as oxide particles, inorganics/organics or water marks present on and/or over the wafer surface and are caused by removal of the oxide films, may be removed in step 42 using the first mixed cleaning solution at a high temperature. Step 42 may inhibit formation residues. The cleaning atmosphere temperature of the high temperature first mixed cleaning solution used to remove the second residues should be higher than that of the ambient temperature first mixed cleaning solution. For example, the process of step 42 may be carried out using the first mixed cleaning solution in which ammonia, hydrogen peroxide and water are mixed in a ratio of 0.8˜1.2:0.8˜1.2:4˜6 and the cleaning atmosphere temperature is in a range of between 50 to 60° C. After the first and second residues are removed, the wafer may be dried in a spin dryer.

In accordance with embodiments, while step 34 is sequentially followed by step 36 and step 38, steps 34, 36 and 38 may be carried out in any order. However, steps 34 to 36 must be carried out prior to steps 40 and 42.

The following Table 1 shows exemplary conditions (e.g., cleaning and drying times, and temperatures) under which the afore-mentioned steps may be performed. In Table 1, “HQDR” means hot quick dump rinse, “F/R” means final rinse, “S/D” means spin dryer drying, “EDR” means end dump rinse and “N/A” means not applicable.

TABLE 1

| | | | | | | | | | | | | | | |
|---|---|---|---|---|---|---|---|---|---|---|---|---|---|---|
| | | | | | Ambient | | | | | | High | | | |
| Cleaning | | | | | temperature | | | | | | temperature | | | |
| solution | sulfuric acid | HQDR | SC2 | HQDR | SC1 | HQDR | F/R | S/D | HF | EDR | SC1 | HQDR | F/R | S/D |

Temperature

| | | | | | | | | | | | | | | |
|---|---|---|---|---|---|---|---|---|---|---|---|---|---|---|
| (° C.) | 100 ± 15 | N/A | 25 ± 5 | N/A | 25 ± 5 | N/A | N/A | N/A | 25 ± 5 | N/A | 55 ± 5 | N/A | N/A | N/A |

Time

| | | |
|---|---|---|
| (sec) | 60~600 | 600 |

60~

| | | | | | |
|---|---|---|---|---|---|
| 600 | 600 | 60~600 | 600 | 600 | 600 |

300~

| | | | | | |
|---|---|---|---|---|---|
| 600 | 600 | 2350 | 600 | 600 | 600 |

The wafer cleaning method in accordance with embodiments illustrated in example FIG. 1 may be carried out before a metal such as cobalt or titanium is sputtered for the purpose of forming a silicide which may be formed after forming a gate spacer. However, embodiments are not limited thereto, and thus, may be applicable in any case so long as first and second residues can be removed from the surface of a site where a metal is sputtered.

Example FIGS. 3A and 3B are pictoral views illustrating the defects of silicide prepared in accordance with a wafer cleaning method. The states of silicide according to pattern lines are illustrated in example FIGS. 3A and 3B. In a case where the first and second residues are present on and/or over the surfaces where suicides will be formed, the silicides have defects, as illustrated in example FIGS. 3A and 3B. However, in the cleaning method in accordance with embodiments, such first and second residues may be removed by performing steps 32 to 42 prior to formation of the suicides. Subsequently, although silicides may be formed by salicide methods, the silicide does not have the defects illustrated in example FIGS. 3A and 3B.

As apparent from the foregoing, in comparison to other methods which employ only a hydrofluoric acid cleaning solution and a first mixed cleaning solution to clean wafers, the wafer cleaning method in accordance with embodiments further employs at least one of a sulfuric acid cleaning solution, an ambient-temperature first mixed cleaning solution and a ambient-temperature second mixed cleaning solution to clean wafers. Accordingly, efficient removal of the first and second residues from the surfaces of the gate electrode and/or source/drain regions can be performed prior to formation of silicide layers thereon and/or thereover. As a result, it is possible to prevent silicide from being formed on due to residues during subsequent processes, i.e., silicide formation processes and thus to avoid any yield loss of silicide caused by residues.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cleaning method comprising:
removing a first residue from at least one predetermined area of a wafer using at least one selected from a sulfuric acid cleaning solution, a first mixed cleaning solution and a second mixed cleaning solution; and then
removing oxide films from the at least one predetermined area using a diluted hydrofluoric acid cleaning solution; and then
removing a second residue derived from the removal of the oxide films, using the first mixed cleaning solution,
wherein the first mixed cleaning solution comprises a mixture of ammonia, hydrogen peroxide and water and the second mixed cleaning solution comprises a mixture of hydrochloric acid (HCl), hydrogen peroxide (H₂O₂) and water (H₂O).

2. The method of claim 1, wherein the the at least one predetermined area comprises an area on which a metal compound layer will be formed.

3. The method of claim 2, wherein the method is conducted before forming the metal compound layer but after formation of a gate spacer on the wafer.

4. The method of claim 1, wherein the the at least one predetermined area comprises an uppermost surface of a source/drain electrode and a gate electrode, respectively.

5. The method of claim 1, wherein the metal compound layer comprises a silicide.

6. The method of claim 1, wherein removing the second residue is performed at a higher cleaning atmosphere temperature than that used during the removal of the first residue.

7. The method of claim 1, wherein removing the oxide film using the dilute hydrofluoric acid cleaning solution is conducted a plurality of times.

8. The method of claim 1, wherein removing the oxide films comprises:
exposing at least the predetermined area to a diluted diluted hydrofluoric acid cleaning solution comprising a mixture of water and hydrofluoric acid (HF) at a ratio of 80˜120:0.8˜1.2 and at a temperature of between 20 to 30° C.

9. The method of claim 1, wherein removing the second residue comprises:
exposing at least the predetermined area to the first mixed cleaning solution using the first mixed solution at a ratio of 0.8˜1:0.8˜1.2:4˜6 and at a temperature of between 50 to 60° C.

10. The method of claim 1, wherein the sulfuric acid cleaning solution comprises a mixture of sulfuric acid and hydrogen peroxide in a ratio of 6:1 and is used at a temperature of between 85 to 115° C.

11. The method of claim 1, wherein the second mixed cleaning solution comprises a mixture of hydrochloric acid, hydrogen peroxide and water at a ratio of 0.8˜1:1.6˜2.4:8˜12 and is used at a temperature of between 20 to 30° C.

12. The method of claim 1, wherein removing the first residue comprises:
exposing at least the predetermined area to the first mixed cleaning solution comprising a mixture of ammonia, hydrogen peroxide and water at a ratio of 0.8˜1:0.8˜1:16˜24 and a temperature of between 20 to 30° C.

13. The method of claim 1, further comprising, after removing the second residue, drying the wafer.

14. A method comprising:
performing a first cleaning process on a surface of a gate electrode and a source/drain electrode, respectively, using a first cleaning solution; and then
performing a second cleaning process on the surface of the gate electrode and the source/drain electrode, respectively, using a second cleaning solution; and then
performing a third cleaning process on the surface of the gate electrode and the source/drain electrode, respectively, using the second cleaning solution; and then
performing a fourth cleaning process on the surface of the gate electrode and the source/drain electrode, respectively, using a third cleaning solution; and then
performing a fifth cleaning process on the surface of the gate electrode and the source/drain electrode, respectively, using the second cleaning solution.

15. The method of claim 14, wherein performing the first cleaning process comprises:
exposing the surface of the gate electrode and the source/drain electrode to the first cleaning solution comprising a mixture of sulfuric acid and hydrogen peroxide at a temperature ranging between 85 to 115° C.

16. The method of claim 14, wherein performing the second cleaning process comprises:
exposing the surface of the gate electrode and the source/drain electrode to the second cleaning solution comprising a mixture of hydrochloric acid, hydrogen peroxide and water at a temperature ranging between 20 to 30° C.

17. The method of claim 14, wherein performing the fourth cleaning process comprises:
exposing the surface of the gate electrode and the source/drain electrode to the third cleaning solution comprising a mixture of hydrofluoric acid and water at a temperature ranging between 20 to 30° C.

18. The method of claim 14, wherein the fourth cleaning process is performed a plurality of times.

19. The method of claim 14, wherein performing the fifth cleaning process comprises:
exposing the the surface of a gate electrode and a source/drain electrode to the second cleaning solution comprising a mixture of hydrochloric acid, hydrogen peroxide and water at a temperature ranging between 50 to 60° C.

20. The method of claim 14, further comprising, after performing the fifth cleaning process, drying the wafer.
